(19) United States
(12) Patent Application Publication
(10) Pub. No.: US 2014/0244776 A1
(43) Pub. Date: Aug. 28, 2014

(54) DEVICE, AND METHOD AND SYSTEM FOR MONITORING MULTIPLE DEVICES

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: MING-TSUNG CHEN, New Taipei (TW); MING-FENG TSAI, New Taipei (TW); YA-JUN ZHAO, Shenzhen (CN)

(73) Assignees: HON HAI PRESICION INDUSTRY CO., LTD., New Taipei (TW); HONG FU JIN PRECISION INDUSTRY (ShenZhen) CO., LTD, Shenzhen (CN)

(21) Appl. No.: 14/192,788

(22) Filed: Feb. 27, 2014

(30) Foreign Application Priority Data
Feb. 27, 2013 (CN) 2013100615637

(51) Int. Cl. H04L 29/08

(52) U.S. Cl. CPC H04L 67/1044
USPC 709/211

(57) ABSTRACT

A method and a system for monitoring at least one device group each having a master device and multiple slave devices are provided. The multiple slave devices are connected in sequence and are finally connected to the master device. Each device stores a multi-bits string, wherein the value of each bit of the string associates with the status of a device according to the connection sequence of the device group. Each device self-tests its own status and outputs a corresponding self-test signal. Each device updates one bit of the stored string corresponding to the device with the output self-test signal, and updates the other bits of the stored string with corresponding bits of a multi-bits string transmitted from a connected rear device. Each slave device transmits the updated stored string to a connected previous device, and the master device transmits the updated stored string to a remote server for monitoring.

### BACKGROUND

1. Technical Field

The present disclosure relates to remote monitoring technology, and particularly to a device, and a method and a system for monitoring multiple devices.

2. Description of Related Art

When monitoring statuses of multiple devices, timely detection and warning of faults of these devices is very important. However, some devices are capable of self-testing for error and warning of faults, it is still difficult to effectively monitor the status of each device in a device group using these existing monitoring systems.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic diagram of an embodiment of a system for monitoring a device group.

FIG. 2 is a block diagram of each device in the device group of FIG. 1.

FIG. 3 is a schematic diagram of a multi-bits string stored in each of the devices of FIG. 2.

FIG. 4 is a flowchart illustrating a method for monitoring the device group of FIG. 1.

### DETAILED DESCRIPTION

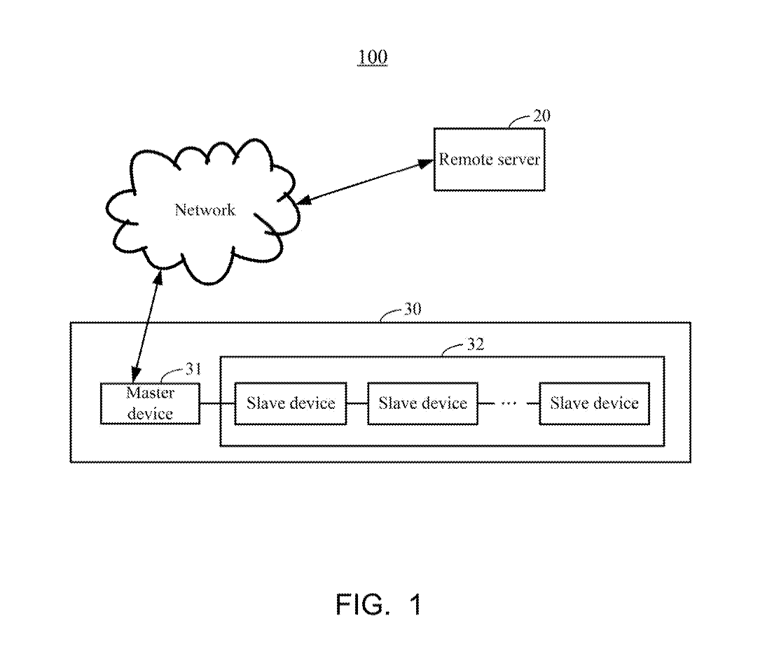

FIG. 1 shows a monitoring system 100 for monitoring at least one device group 30 using a remote server 20. The device group 30 includes a master device 31 and multiple slave devices 32. The master device 31 and the slave devices 32 are capable of self-test function. The multiple slave devices 32 are connected in sequence and are finally connected to the master device 31, in order to transmit status information to the master device 31. The master device 31 communicates with the remote server 20 through a network, and transmits the status information of the device group 30 to the remote server 20 for monitoring. The master device 31 also receives control information from the remote server 20, and transmits the control information to the devices in the device group 30 for execution.

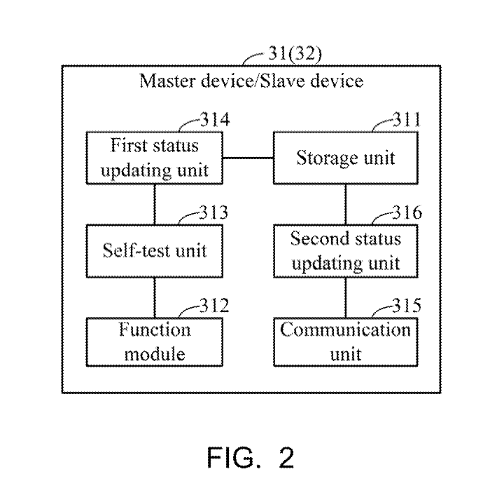

FIG. 2 shows that in one embodiment, each device in the device group 30 includes a storage unit 311, a function module 312, and a self-test unit 313. The storage unit 311 is configured to store a multi-bits string, wherein the value of each bit of the string associates with the status of a device in the device group 30 according to the connection sequence of the device group 30. That is, the multi-bits string represents the statuses of the multiple devices in the device group 30.

The self-test unit 313 is configured to check the function module 312 to determine whether the status of the function module 312 is normal, and outputs a corresponding self-test signal. In one embodiment, if the self-test unit 313 determines that the status of the function module is normal, the self-test unit 313 outputs a first self-test signal, if not, the self-test unit 313 outputs a second self-test signal. In one embodiment, the first self-test signal is predetermined to a high logic level signal “1”, and the second self-test signal is predetermined to a low logic level signal “0”. In an initial state, the value of each bit of the string is assigned to “1”.

Each device in the device group 30 further includes a first status updating unit 314. The first status updating unit is configured to update the value of one bit of the stored string corresponding to the device with the self-test signal output from the self-test unit 313, in order to make the value of the bit of the string updated by the first status updating unit 314 associate with the actual status of the device. In one embodiment, when the device is in an abnormal status, that is, the self-test unit 313 outputs the second self-test signal “0”, the first status updating unit 314 updates the value of one bit of the string corresponding to the device to “0”.

Each device in the device group 30 further includes a communication unit 315 and a second status updating unit 316. Each device communicates with other connected devices through the communication unit 315. The second status updating unit 316 is configured to update the values of the other bits of the stored string with the values of corresponding bits of a multi-bits string transmitted from a connected rear device, in order to make the values of the other bits of the string updated by the second status updating unit 316 associate with the actual statuses of the following rear devices.

In one embodiment, the second status updating unit 316 is a logic “AND” unit, and is configured to make an “AND” formula between the string stored in the device and the string transmitted from a rear device, and replace the string stored in the device with the “AND” formula result.

The communication unit 315 of each slave device 32 is further configured to transmit the updated stored string to a connected previous device.

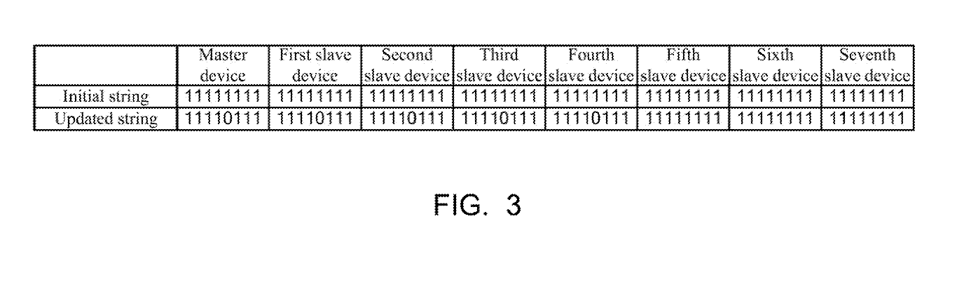

For example, as shown in FIG. 3, in an initial state, the string stored in each device in the device group 30 with eight devices is assigned to 11111111. If the fifth device in the device group 30, which is the fourth slave device, is abnormal, the fifth bit of the string stored in the fifth device is updated to “0”. That is, the string stored in the fifth device is updated to 11110111, and then the strings stored in the fourth device, the third device, the second device, and the first device are all updated to 11110111. Finally, the master device 31 transmits the updated stored string 11110111 to the remote server 20, and the remote server 20 can checkout the fifth abnormal device.

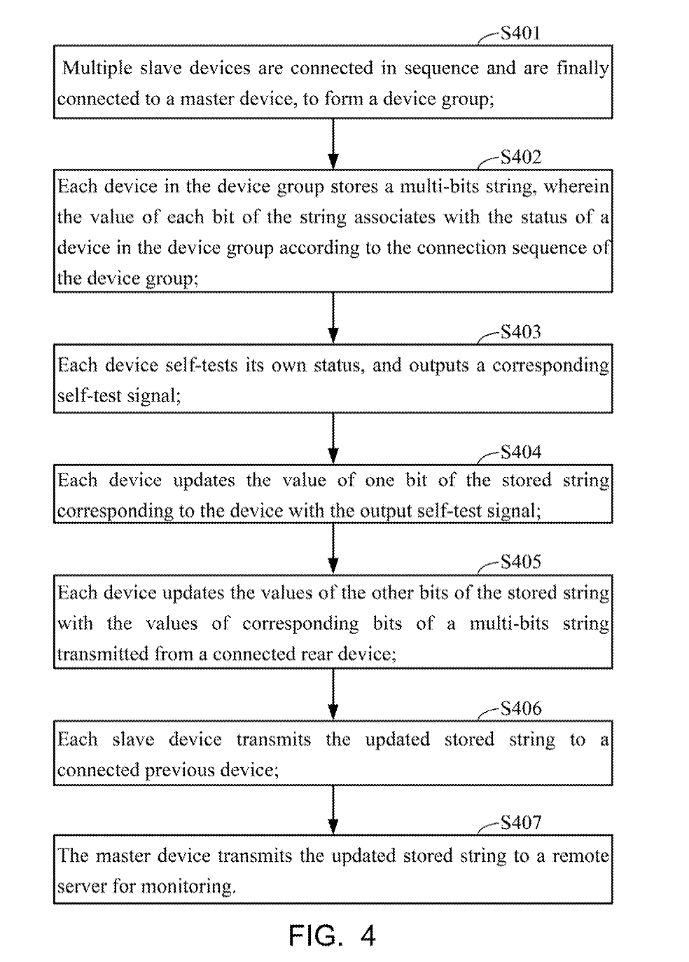

FIG. 4 is a flowchart illustrating a method for monitoring at least one device group 30 each having a master device 31 and multiple slave devices 32.

In step S401, each device in the device group 30 stores a multi-bits string, wherein the value of each bit of the string associates with the status of a device in the device group 30 according to the connection sequence of the device group 30.

In step S402, each device in the device group 30 self-tests its own status, and outputs a corresponding self-test signal.

In step S403, each device updates the value of one bit of the stored string corresponding to the device with the output self-test signal, in order to make the value of the bit of the string updated by the first status updating unit 314 associate with the actual status of the device.

In step S404, each device updates the values of the other bits of the stored string with the values of corresponding bits of a multi-bits string transmitted from a connected rear device, in order to make the values of the other bits of the string updated by the second status updating unit 316 associate with the actual statuses of the following rear devices.

In step S405, each slave device 32 transmits the updated stored string to a connected previous device.

In step S406, the master device 31 transmits the updated stored string to the remote server 20 for monitoring.

Therefore, the remote server 20 can monitor the status of each device in real time.

In one embodiment, when the fault of an abnormal device is eliminated, the remote server 20 transmits control information to the master device 31, in order to initialize the string stored in each device in the device group 30. In one embodiment, the value of each bit of the string is initialized to “1”.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A system for monitoring at least one device group each comprising a master device and multiple slave devices, wherein the multiple slave devices are connected in sequence and are finally connected to the master device; wherein each device in the device group comprises:
a storage unit configured to store a multi-bits string, wherein the value of each bit of the string associates with the status of a device in the device group according to the connection sequence of the device group;
a function module and a self-test unit, wherein the self-test unit is configured to check the function module to determine whether the status of the function module is normal, and outputs a corresponding self-test signal;
a first status updating unit configured to update the value of one bit of the stored string corresponding to the device with the self-test signal output from the self-test unit;
a communication unit, wherein each device communicates with other connected devices through the communication unit; and
a second status updating unit configured to update the values of the other bits of the stored string with the values of corresponding bits of a multi-bits string transmitted from a connected rear device;
wherein the communication unit of each slave device is further configured to transmit the updated stored string to a connected previous device, and the communication unit of the master device is further configured to transmit the updated stored string to a remote server for monitoring.

2. The system as described in claim 1, wherein the master device further receives control information from the remote server, and transmits the control information to the devices in the device group for execution.

3. The system as described in claim 1, wherein the self-test unit outputs a first self-test signal if it determines that the status of the function module is normal, and outputs a second self-test signal if it determines that the status of the function module is abnormal.

4. The system as described in claim 2, wherein the first self-test signal is predetermined to a high logic level signal “1”, the second self-test signal is predetermined to a low logic level signal “0”, and the value of each bit of the string is assigned to “1” in an initial state.

5. The system as described in claim 4, wherein the second status updating unit is a logic “AND” unit, which is configured to make an “AND” formula between the string stored in the device and the string transmitted from the rear device, and replace the string stored in the device with the “AND” formula result.

6. A device connected to other similar devices in sequence to constitute a device group, the device comprising:
a storage unit configured to store a multi-bits string, wherein the value of each bit of the string associates with the status of a device in the device group according to the connection sequence of the device group;
a function module and a self-test unit, wherein the self-test unit is configured to check the function module to determine whether the status of the function module is normal, and outputs a corresponding self-test signal;
a first status updating unit configured to update the value of one bit of the stored string corresponding to the device with the self-test signal output from the self-test unit;
a communication unit, wherein the device communicates with other connected similar devices through the communication unit; and
a second status updating unit configured to update the values of the other bits of the stored string with the values of corresponding bits of a string transmitted from a connected rear similar device;
wherein if the device acts as a slave device in the device group, the communication unit is further configured to transmit the updated stored string to a connected previous similar device; if the device acts as a master device, the communication unit is further configured to transmit the updated stored string to a remote server for monitoring.

7. The device as described in claim 6, wherein if the device acts as a master device, the device further receives control information from the remote server, and transmits the control information to the devices in the device group for execution.

8. The device as described in claim 6, wherein the self-test unit outputs a first self-test signal if it determines that the status of the function module is normal, and outputs a second self-test signal if it determines that the status of the function module is abnormal.

9. The device as described in claim 8, wherein the first self-test signal is predetermined to a high logic level signal “1”, the second self-test signal is predetermined to a low logic level signal “0”, and the value of each bit of the string is assigned to “1” in an initial state.

10. The device as described in claim 9, wherein the second status updating unit is a logic “AND” unit, which is configured to make an “AND” formula between the string stored in the device and the string transmitted from the rear device, and replace the string stored in the device with the “AND” formula result.

11. A method for monitoring at least one device group each comprising a master device and multiple slave devices, wherein the multiple slave devices are connected in sequence and are finally connected to the master device; the method comprises:
each device in the device group storing a multi-bits string, wherein the value of each bit of the string associates with the status of a device in the device group according to the connection sequence of the device group;
each device self-testing its own status, and outputting a corresponding self-test signal;
each device updating the value of one bit of the stored string corresponding to the device with the output self-test signal;
each device updating the values of the other bits of the stored string with the values of corresponding bits of a multi-bits string transmitted from a connected rear device;
each slave device transmitting the updated stored string to a connected previous device;
the master device transmitting the updated stored string to a remote server for monitoring.

12. The method as described in claim 11, further comprising the master device receiving control information from the remote server, and transmitting the control information to the devices in the device group for execution.
